(19) United States
(12) Patent Application Publication
(10) Pub. No.: US 2011/0216014 A1
(43) Pub. Date: Sep. 8, 2011

(54) MULTIMEDIA WIRELESS TOUCH CONTROL DEVICE

(76) Inventors: Chih-Meng WU, Shi Chih City (TW); Shun-Keng Chen, Shi Chih City (TW)

(21) Appl. No.: 12/718,137

(22) Filed: Mar. 5, 2010

(51) Int. Cl. G06F 3/041

(52) U.S. Cl. 345/173; 178/18.03

(57) ABSTRACT

A multimedia wireless touch control device includes a G-sensor, a touch pad, a wireless transmit module, and also includes an electric power storage. The electric power storage supply the wireless touch control device with electric power when it is used separately, and in this instance, the wireless touch control device can send wireless signal to the device by a wireless transmitter. All of the above mentioned parts compose a portable touch control device which providing wireless transmission functions. The G-sensor can induct the gradient of the wireless touch control device for providing the wireless touch control device with operation functions like scroll bar and the resolution adjust. The functions of the present invention can replace the input functions of computer keyboard, the functions of computer mouse and multimedia wireless touch control device, it also can replace the functions of handwritten board, joystick and multimedia remote control device.

### BACKGROUND OF THE INVENTION

1. Field of the Invention

The invention relates to a multimedia wireless touch control device, more particularly to a multimedia wireless touch control device which with functions of wireless touch pad, handwritten board, joystick, multimedia remote device and computer mouse.

2. Description of the Related Art

In the field of personal mobile information processing, notebook (NB) has replaced desktop computer for its portability, and “netbook” has introduced to meet user's requirements, but when these portable communication device such as notebook, mobile phone, portable multimedia player (PMP) come into use, consumer will always thirst for a simpler and more convenient operation experience than existing device. The demands for application of technology in Pointing Stick and Touch Pad maintain a steady growth, users expect that it will replace the functions of conventional computer keyboard and mouse.

Nowadays mainstream design of touch pad is capacitive type touch pad. The capacitive type touch pad combine transparent electrode with human body and produce electrostatic bonding and change the capacitance, and then produce an induction current, the controller detect the induction current and calculate the coordinate, but the capacitance of capacitive type touch pad is easily influenced by static, so it's difficult to design a better circuit diagram. The principle of capacitive type touch pad is while user's finger touching the touch pad, the capacitance change, the control circuit of the touch pad will detect the change and switch it into coordinate (X, Y, θ), touch pad inducting the finger's movements by capacitance induction, when user's finger touch the sensor, it will produce a analogy signal to the control device, then the control device will convert this analogy signal into a digital signal, and then the touch control driver inside the computer calculate and process the signal, at last the coordinate of the touch point be shown on the display of the communication device. Except basic two-dimensional functions, like cursor pointer, scrolling, the communication device can set a touch control driver inside the system for supporting functions of smart edge, corner selection, or multi-finger operation, it make the functions and the operation of the touch pad approaching to the user's habit and it can replace the functions of computer mouse.

Nowadays in notebook the control device of the capacitive type touch pad use PS/2 as a transport protocol, the control device convert the analogy signal from the touch sensor into digital signal, then the driver inside the computer calculate and process the signal, so we can make various design and functions add about the touch control driver, such as multi-finger gesticulating input operation, operation system for multi-language users, handwritten identify support, multi-screen system support, computer games support, this increase the added value of the touch pad and the programmer is able to design software to meet client's requirements, so existing capacitive type touch pad allow users to perform multi-finger gesticulating input operation, single finger sliding, single finger cursor pointer and single finger selection, and it can replace part of functions of computer keyboard with multi-finger gesticulating input operation, and facilitate the operation. A touch pad is no mechanical fatigue, and its useful life is generally longer than a conventional keyboard. All of those factors allow the industrial design of the portable communication device becoming more innovative and attractive.

But present touch pad is always setting in portable communication device immovably, and only replace part of functions of computer keyboard and mouse, not have the functions of handwritten board, joystick or multimedia remote control device, it restrict the usage of touch pad, and touch pad is also restricted in its size and not enough resolution, when double click an error easily occur. Because the present touch pad is designed not to be separated, it can not fulfill the requirements of a portable and multi-use or multi-purpose communication device. So, the inventor of the present invention search and create a solution to make up the shortage or defect of existing technology.

### SUMMARY OF THE INVENTION

A main object of the present invention is to provide a multimedia wireless touch control device including a G-sensor, a touch pad, a wireless transmit module and a electric power storage. The touch control device can send wireless signal to communication device which with a wireless transmitter, when it is separated form the communication device, forming a portable wireless transmission touch control device.

Another object of the present invention is to provide a multimedia wireless touch control device, the G-sensor inducts the gradient of the wireless touch control device when the touch pad being used separately, so the wireless touch control device can be provided with operation functions like a scroll bar and resolution adjust, for providing the wireless touch control device with functions of joystick and multimedia remote control device.

The third object of the present invention is to provide a multimedia wireless touch control device, using double touch pad support both hands operation, and touch pad can be used as the left and right key of joystick.

The fourth object of the present invention is to provide a multimedia wireless touch control device, with the operation of the light guide, provide multifold graphical interfaces and handwritten functions for operator.

In order to achieve the above-mentioned object, the present invention provide a multimedia wireless touch control device, comprises a touch-control pane I, which is consists of a upper layer and a lower layer. The upper layer includes a G-sensor, a touch pad and a wireless transmit module, the lower layer includes a electric power storage. The G-sensor inducts the gradient of the wireless touch control device when it is separated form the communication device, then the wireless touch control device can adjust the resolution and is able to replace the functions of the mouse wheel and scroll bar of the Windows files.

In the present invention, for allow both hands operation, several touch pad can be set symmetrically in the touch-control panel to support multi-point input, and make functions of the touch-control panel compatible with new operate system having touch control functions like Windows 7.

About the structure of the touch pad, the light guide is used for supporting multifold graphical interfaces and handwritten functions.

In the present invention the touch pad is designed to a built-in structure so it is easily connected to multifarious communication device, and the power charge device of those communication device can charge the touch control device by charging the electric power storage of the lower layer of the touch pad, when the touch control device separated form the communication device and in use, the electric power storage will provide power for wireless transmit module, then the touch control device can send wireless signal to communication device which with a wireless transmitter, providing the device with functions of joystick and multimedia remote device.

When the touch control device used separately, taking the advantage of the G-sensor induction, the change of three-dimensional acceleration caused by kinds of different operation can be designed into code parameter in advance, for example, through a shake or a double click of the touch control device user can change the page of the Windows.

In the present invention the G-sensor is playing an important role, it makes the processor of the whole touch control device become an intelligent system, then the change of three-dimensional acceleration caused by kinds of different operation can be designed into code parameter in advance. When the wireless touch control device makes gradient in hands of operator, the G-sensor will induct this gradient, the processors process the data form the G-sensor and confirm the types of the data, then send command to communication device which with a wireless transmitter by the wireless transmit module, and then the touch control device can be used as joystick or multimedia remote control device and can fulfill the requirements of multi-use.

The G-sensor inducts the gradient and produces a set of data, the processor process the data intelligent. The data is compare with the code parameter which the movements be designed into in advance. The processor confirm the type of the movements, then send corresponding command to communication device, the communication device responds to the movements according to the command, providing an separable intuitive operation system, and it also simplify the move instruction, make the touch control device adaptable to multi-use.

### BRIEF DESCRIPTION OF THE DRAWINGS

The present invention will become more fully understood from the detailed description given in the illustration below only, and thus does not limit the present invention, wherein:

FIG. 1 is a service condition view of the present invention; and

FIG. 2 is a structural representation view of the touch control board.

### DETAILED DESCRIPTION OF THE INVENTION

Reference will now be made to the drawing to describe the present invention in detail.

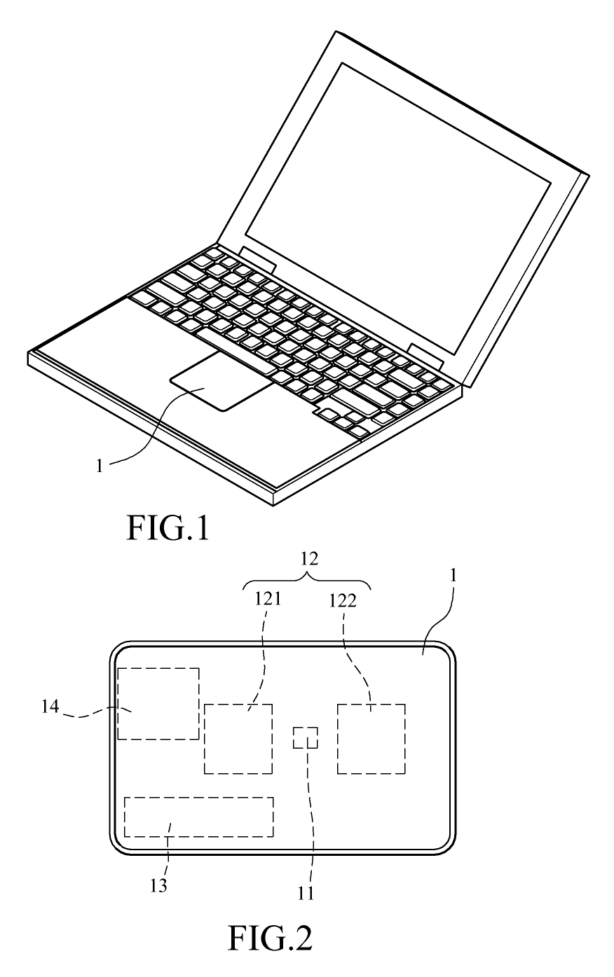

Please refer to FIGS. 1 and 2, an embodiment of the present invention is shown. The touch control device can be connected to multi-portable communication device, or wireless control video game. The touch control device is basically a touch-control panel 1, the size of the touch-control panel 1 depends on the specification of the portable communication device, touch-control panel 1 is generally a rectangle figure. The touch control device can be connected to multifarious communication device with a built-in structure, it also can be used separately from the communication device, forming a portable wireless transmission touch control device.

The touch-control panel 1, which consists an upper layer and a lower layer, the upper layer includes a G-sensor 11, a touch pad 12 and a wireless transmit module 13. The lower layer includes an electric power storage 14. The G-sensor 11 inducts the gradient of the wireless touch control device when it is separated form the communication device. Then the wireless touch control device can adjust the resolution, and is able to replace the functions of the mouse wheel, scroll bar of Windows files. The touch pad 12 can be set symmetrically allow both hands operation, and to support multi-point and input multi-touch functions. So the touch control device is compatible with new operate system with touch control functions like Windows 7. The wireless transmit module 13 sends wireless signal to communication device via a wireless transmitter, it make the touch control device to be used as joystick or multimedia remote device. The wireless transmit module 13 may be a wireless communication module, a Bluetooth communication module or a Zigbee communication module.

When carrying out the invention, the G-sensor 11, the touch pad 12, the wireless communication module 13 and the electric power storage 14 can be set in the touch-control panel 1 of single layer when necessary.

In the present invention, the operation mode of the touch control device can support single hand operation or both hands operation. Single hand operation means uses a single finger touch control the display, perform the functions like selection or browsing. And a simulated keyboard is provided to support single finger input, these functions make input operation simple and convenient. Taking advantage of the G-sensor induction, the change of three-dimensional acceleration caused by kinds of different operations can be designed into code parameter in advance, for example, by a shake or a double click of the touch control device the operator can change the page of Windows. When the wireless touch control device makes gradient in hands of operator, the G-sensor will induct the gradient and adjust the resolution, and the inducting functions are able to replace the functions of the mouse wheel, scroll bar of Windows file.

Both hands operation can exist as touch control function of a touch computer like drawing or make electronic books, it also can be used as the left and right key of joystick. So the program can be designed that when pressing the left touch pad 121, the operator can perform dragging operation through touching the right touch pad 122, or the left touch pad 121 to control the resolution, the right touch pad 122 can carry out the dragging operation.

As a part of the touch pad 12, the light guide is used for supporting multifold graphical interfaces and handwritten functions.

In the present invention the touch control device is designed to a built-in structure so it is easily connected to multifarious communication devices, and becomes a part of the portable communication device. The power charging device of communication device can charge the touch control device by charging the electric power storage 14 of the lower layer of the touch-control panel 1. When the touch control device is separated form the communication device and in use, the electric power storage 14 can provide power for wireless transmit module 13. Then the touch control device can send wireless signal to communication device by a wireless transmitter, providing the device with functions of joystick and multimedia remote control device.

Touching control personal computer will be a mainstream design in future because humanization design and user-friendly interface is always acceptable to consumer. When the touch control device is engage with a portable communication device, it can be used as multipoint input touch pad or handwritten board; when the touch control device is used separately from the portable communication device, it can be used as joystick or multimedia remote device. Taking advantage of the built in G-sensor, the touch control device can support video game like Wii, forming a multi-use or a multipurpose multimedia wireless touch control device.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A multimedia wireless touch control device with a built-in structure connecting to an information processing device or a communication device, comprising a touch-control panel (1), the touch-control panel (1) including an upper layer and a lower layer, the upper layer including a G-sensor (11), a touch pad (12) and a wireless transmit module (13), the lower layer including an electric power storage (14).

2. The multimedia wireless touch control device as recited in claim 1, wherein the touch control device is separated form the information processing device or communication device, providing a portable touch control device.

3. The multimedia wireless touch control device as recited in claim 2, wherein the touch pad (12) supporting single hand operations.

4. The multimedia wireless touch control device as recited in claim 2, wherein the touch pad (12) supporting both hands operations.

5. The multimedia wireless touch control device as recited in claim 2, wherein using the G-sensor (11) induction method, the change of the three-dimensional acceleration caused by kinds of different operations is designed into code parameter in advance, and setting in different kinds mode of operations in advance.

6. The multimedia wireless touch control device as recited in claim 5, wherein the G-sensor is inducting a gradient and adjusting a resolution, when the touch control device is used separately.

7. The multimedia wireless touch control device as recited in claim 1, wherein the touch control device used separately, the G-sensor inducting the gradient of the touch pad, setting three-dimensional operation, adjusting the resolution, and used as scroll bar of Windows files.

8. The multimedia wireless touch control device as recited in claim 1, wherein the touch pad (12) is set on both sides of the touch-control panel (1) symmetrically, for supporting both-hand operations and multipoint inputs.

9. The multimedia wireless touch control device as recited in claim 8, wherein the touch pad (12) is supporting multi-touch operation on a display.

10. The multimedia wireless touch control device as recited in claim 1, wherein the wireless transmit module (13) sends a signal to an equipment with a wireless transmitter, forming a wireless transmission.

11. The multimedia wireless touch control device as recited in claim 1, wherein the touch control pad (12) is supporting multifold graphical interfaces by a light guide.

12. The multimedia wireless touch control device as recited in claim 1, wherein the touch control device having a charging and an electric power storage (14) in the lower layer of the touch-control panel (1), and the electric power storage (14) can be charged.

13. The multimedia wireless touch control device as recited in claim 1, wherein the touch control device is used separately from the information processing device or the communication device, used as a joystick or a multimedia remote control device.

14. A multimedia wireless touch control device, wherein the touch control device is connected to an information processing device or a communication device by a built-in structure, the touch control device comprising a single-layer structure touch-control panel (1), a G-sensor (11), a touch pad (12), a wireless transmit module (13) and an electric power storage (14) set inside the panel.

15. A multimedia wireless touch control device with a built-in structure connecting to an information processing device or a communication device, comprising a touch-control panel (1), the touch-control panel (1) including an upper layer and a lower layer, the upper layer including a G-sensor (11), two touch pads (121, 122) installed symmetrically in the upper layer and a wireless transmit module (13), the lower layer including an electric power storage (14).
